(19) United States
(12) Patent Application Publication
(10) Pub. No.: US 2014/0075391 A1
(43) Pub. Date: Mar. 13, 2014

(54) DISPLAY CONTROL DEVICE, DISPLAY CONTROL SYSTEM, STORING MEDIUM, AND DISPLAY METHOD

(71) Applicant: NINTENDO CO., LTD., Kyoto (JP)

(72) Inventors: Munetaka TSUDA, Kyoto (JP); Yasuto KAKIMOTO, Kyoto (JP); Ryoma AOKI, Kyoto (JP)

(73) Assignee: NINTENDO CO., LTD., Kyoto (JP)

(21) Appl. No.: 13/790,224

(22) Filed: Mar. 8, 2013

(30) Foreign Application Priority Data
Sep. 11, 2012 (JP) 2012-199957

(51) Int. Cl. G06F 3/0482

(52) U.S. Cl. CPC G06F 3/0482
USPC 715/840

(57) ABSTRACT

An example information-processing device includes: a display control unit that causes a display unit to display a button image assigned to a function, the button image being selectable by a user, and an object superimposed on the button image; a processing unit that performs a processing corresponding to the function when the button image displayed by the display unit is selected by a user; and a notification control unit that notifies a status of at least the processing performed by the processing unit by changing an appearance of the object displayed by the display unit.

### CROSS-REFERENCE TO RELATED APPLICATIONS

This application is based on and claims priority under 35 USC 119 from Japanese Patent Application No. 2012-199957 filed on Sep. 11, 2012.

### FIELD

The technology herein relates to notification of a processing status.

### BACKGROUND AND SUMMARY

GUIs (Graphical User Interfaces) in computers provide users with a variety of information. For notification of a processing status, a display area such as a progress bar may be provided.

There is provided an information-processing device includes: a display control unit that causes a display unit to display a button image assigned to a function, the button image being selectable by a user, and an object superimposed on the button image; a processing unit that performs a processing corresponding to the function when the button image displayed by the display unit is selected by a user; and a notification control unit that notifies a status of at least the processing performed by the processing unit by changing an appearance of the object displayed by the display unit.

### BRIEF DESCRIPTION OF THE DRAWINGS

FIG. 1 shows a non-limiting example of a functional configuration of a display control device.

FIG. 2 shows a non-limiting example of a hardware configuration of an information-processing device.

FIG. 3 shows a non-limiting example of a screen displayed by an information-processing device.

FIG. 4 shows a non-limiting example of a screen displayed by an information-processing device.

FIG. 5 shows a non-limiting example of animation files.

FIG. 6 is a flowchart illustrating a non-limiting example of processing performed by an information-processing device.

FIG. 7 is a flowchart illustrating a non-limiting example of processing performed by an information-processing device.

### DETAILED DESCRIPTION OF NON-LIMITING EXAMPLE EMBODIMENTS

### 1. Summary of Example Embodiments

Example embodiments are characterized by display control performed where an object is superimposed on a button image. In the example embodiments, a first feature is provided where a processing status is notified to a user by way of the object. The object provides notification of a processing status. The processing, a status of which is notified to the user by way of the object, may include a variety of types of processing. The object may provide notification relevant to a processing corresponding to a function assigned to a button image, with the object being superimposed on the button image. Alternatively, the object may provide notification relevant to a function that is different from the function assigned to the button image; namely, a function that is not directly relevant to an input operation by a user to the button image or to the function assigned to the button image. For example, the object may, in a case where an image other than the button image is displayed, provide notification of a status of a processing corresponding to a function relevant to an image other than the button image.

In the example embodiments, a second feature is provided where an object superimposed on a button image is drawn using 3D computer graphics (3DCG). Files containing objects drawn using 3D computer graphics, each of which files correspond to a processing status to be notified, are prepared, and the files are changed according to a processing status and are played, so that an animation is displayed in accordance with a current processing status. When files are changed, a gap between the objects is filled using interpolation processing. Accordingly, by way of an object a user can be notified of a change in processing status easily and in a natural manner. The object may be a character in a game or an avatar. If there are plural users, different avatars may be used by different users.

Display of an object described in the foregoing is realized by an example configuration described below.

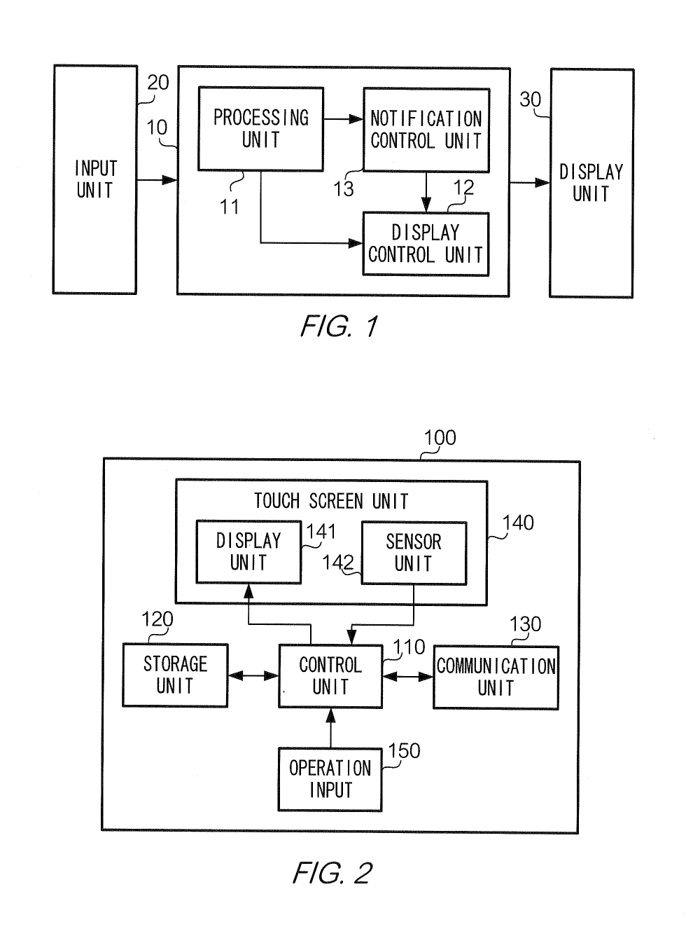

FIG. 1 is a block diagram showing a functional configuration of display control device 10 according to an example embodiment. Display control device 10 is provided in an information-processing device including input unit 20 and display unit 30. Alternatively, display control device 10 is provided independently from a device including input unit 20 and/or display unit 30. Input unit 20 is a unit used for input by a user of an operation to display control device 10. Display unit 30 is a unit that displays an image in a display area. Display control device 10 includes processing unit 11, display control unit 12, and notification control unit 13.

Processing unit 11 is a unit that performs processing, and the processing can be single processing or plural processing. Processing unit 11 provides a function corresponding to a performed processing. Functions provided by processing unit 11 include a function for displaying a web page, a function for displaying a list of URLs (Uniform Resource Locators) of web pages, and editing the list, and a function for executing a game. The functions may be provided by a single application or by plural different applications.

Display control unit 12 causes display unit 30 to display an image. More specifically, display control unit 12 causes display unit 30 to display, in a display area of display unit 30, a button image, the button being selectable by a user, and a result of a processing by processing unit 11. The button image is an image to which a function is assigned. When a user selects a function by way of the button, a corresponding processing is performed by processing unit 11. In a case that the function performed by processing unit 11 is display of a web page, the web page is displayed. Similarly, when a function performed by processing unit 11 is display of a list of URLs of web pages, the list of URLs of web pages is displayed. Display control unit 12 also has a function of causing display unit 30 to display an object superimposed on a button image.

Notification control unit 13 is a unit that notifies a status of a processing performed by processing unit 11. Notification control unit 13 identifies a status of a processing performed by processing unit 11, and controls display control unit 12 so that the identified processing status is displayed by use of a predetermined display method. Display control unit 12 notifies a processing status to a user under control of notification control unit 13.

Notification control unit 13 provides a notification through a display method in which an object is superimposed on a button image. By observing a change in a display method in which an object is superimposed on a button image, a user can confirm a status of a processing performed by processing unit 11. Also, by selecting a button image on which an object is superimposed, a user can cause a processing operation to be executed. Namely, a button image on which an object is superimposed can be used to notify a user of a processing status and to receive an operation input by a user.

### 2. Embodiment

FIG. 2 is a block diagram showing a hardware configuration of information-processing device 100 according to one embodiment. In this embodiment, information-processing device 100 is a handheld game machine; namely, a game machine of a suitable size to be held in a user's hands and operated by the user. Information-processing device 100 includes control unit 110, storage unit 120, communication unit 130, touch screen unit 140, and operation input unit 150.

Control unit 110 is a unit that controls operations of components of information-processing device 100. Control unit 110 includes a processor such as a CPU (Central Processing Unit) and a memory, which performs the control by executing programs. Storage unit 120 is a unit that stores data. Storage unit 120 includes a storage medium such as a hard disk or flash memory, which stores data used by control unit 110. Storage unit 120 stores data on bookmarks and animation files, which are described later, in addition to programs. Communication unit 130 is a unit that exchanges data. Communication unit 130 connects to a network such as the Internet or a LAN (Local Area Network) or another information-processing device, and exchanges data with a destination unit.

Touch screen unit 140 is a unit that displays an image and receives an operation input by a user. Touch screen unit 140 includes display unit 141 and sensor unit 142. Display unit 141 has a display area (display panel) composed of liquid crystal elements or organic EL (Electroluminescence) elements, and a drive circuit therefor, which displays an image according to display data provided by control unit 110. Sensor unit 142 includes a sensor provided over the display area of display unit 141, which provides coordinate data according to an operation toward the display area to control unit 110. The coordinate data indicates a position indicated by a user in the display area, expressed using coordinates of a coordinate system such as a rectangular coordinate system. The operation input by a user may be an operation performed by touching the display area or by getting close to the display area without contacting it. Also, the operation input by a user may be performed by direct contact with, for example, a finger, or by contact with an instrument, such as a stylus (touch-pen), and the like.

Operation input unit 150 is a unit that receives an operation input by a user. Operation input unit 150 includes keys (or buttons) such as directional keys (arrow keys), which provide key data according to an operation input by a user to control unit 110. The key data may be data indicating whether a key is pressed.

It is to be noted that information-processing device 100 may include only one of sensor unit 142 and operation input unit 150. It is also to be noted that coordinate data and key data are collectively referred to as “operation data.” The operation data are data indicating an operation input by a user.

Information-processing device 100 according to the present embodiment includes display control device 10, input unit 20, and display unit 30, which are described above. In information-processing device 100, control unit 110 is an example of display control device 10 including processing unit 11, display control unit 12, and notification control unit 13. Operation input unit 150 is an example of display control unit 12. Touch screen unit 140 is an example of input unit 20 and display unit 30.

The foregoing is a description of a configuration of information-processing device 100. Information-processing device 100 with the foregoing configuration displays an image according to an operation input by a user. The image includes an avatar object, to be described later. In the present embodiment, information-processing device 100 has a function of a web browser. The function of a web browser includes at least a function of displaying a web page and a function of displaying and managing bookmarks. A processing performed by the web browser changes in accordance with an input operation by a user. A bookmarking function enables display of a list of URLs of web pages; namely, links (hyperlinks), and also enables addition or deletion of a link(s). The management of bookmarks includes addition, deletion, or editing of a link(s).

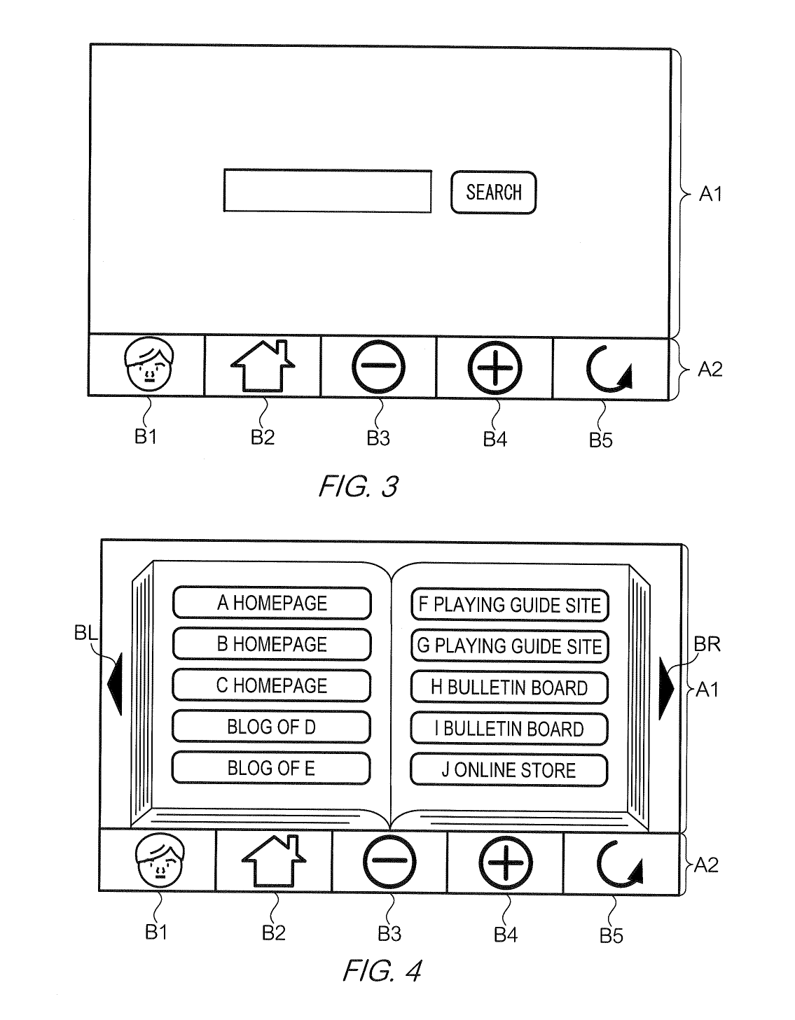

FIGS. 3 and 4 are diagrams showing an example of a screen displayed in information-processing device 100. The screen shown in FIG. 3 includes area A1 for displaying a web page, and area A2 for displaying a toolbar. The screen shown in FIG. 4 is a screen displayed in a case where bookmarks are displayed in area A1, instead of a web page. It may not be necessary that the toolbar is displayed in area A2 when another image (image displayed in area A1) is displayed. The toolbar may be displayed or hidden according to an operation input by a user. When the toolbar is hidden, information-processing device 100 may display a web page in area A2, or display an image different from the toolbar.

In the present embodiment, a bookmark list is represented by an image of a book. On each page of the book, a list of images (icons) corresponding to URLs is displayed. If there are plural URLs to be recorded, bookmarks may be displayed on plural pages. In the present example, if a user selects button image BL, a transition of the screen is made to show that the left page of the book is turned, and if a user selects button image BR, a transition of the screen is made to show that the right page of the book is turned.

In FIGS. 3 and 4, the toolbar includes button images B1, B2, B3, B4, and B5. Each of the button images is an image to which a function is assigned, and is selectable by a user. A user may select a button image by touching the image on touch screen 140, the touch being sensed by sensor unit 142 of touch screen unit 140. Alternatively, selection of a button image may be performed by movement of a cursor by a user using operation input unit 150.

Button image B1 is a button image to which there is assigned a function of switching an image displayed in area A1 from a web page to a bookmark list or vice versa. Button image B2 is a button image to which there is assigned a function of displaying a homepage, or a predetermined web page, which page is displayed when the web browser is started. Button image B3 is an image to which there is assigned a function of reducing a size of a web page on a display. Button image B4 is an image to which there is assigned a function of enlarging a web page on the display. Button image B5 is an image to which there is assigned a function of reloading a web page on the display. On each of button images B2 to B5, a still 2D image is displayed, and this image indicates a function of the button on which it is displayed. Button images B2 to B5 are rectangular in shape.

An object of an animated image, whose appearance continuously changes, is superimposed on button image B 1. In the present embodiment, the object is a polygonal object drawn using 3D computer graphics. The object is also an image of an avatar. The avatar is a graphical representation of a user or a user's alter ego. The avatar may be an image that has been prepared by a user using an application, or an image that has been selected by a user from among images pre-installed in information-processing device 100. Hereinafter, the object superimposed on button image B1 may be referred to as an “avatar object.”

The avatar object has a function of notifying to a user a status of information-processing device 100. For example, the avatar object provides notification about a processing status. The processing may be a processing corresponding to a function displayed in area A1. In the present embodiment, information-processing device 100 provides a notification to a user by displaying a processing status of the web browser or the bookmarking function by way of the avatar object. The notification may include reproduction of a sound effect in addition to display of the object.

It is to be noted that display of the toolbar may be changed according to an image displayed in area A1. Specifically, button images included in the toolbar or a number of button images may differ between a case where a web page is displayed and a case where a bookmark list is displayed. However, according to the present embodiment, button image B1 is required to be displayed continuously, regardless of an image displayed in area A1.

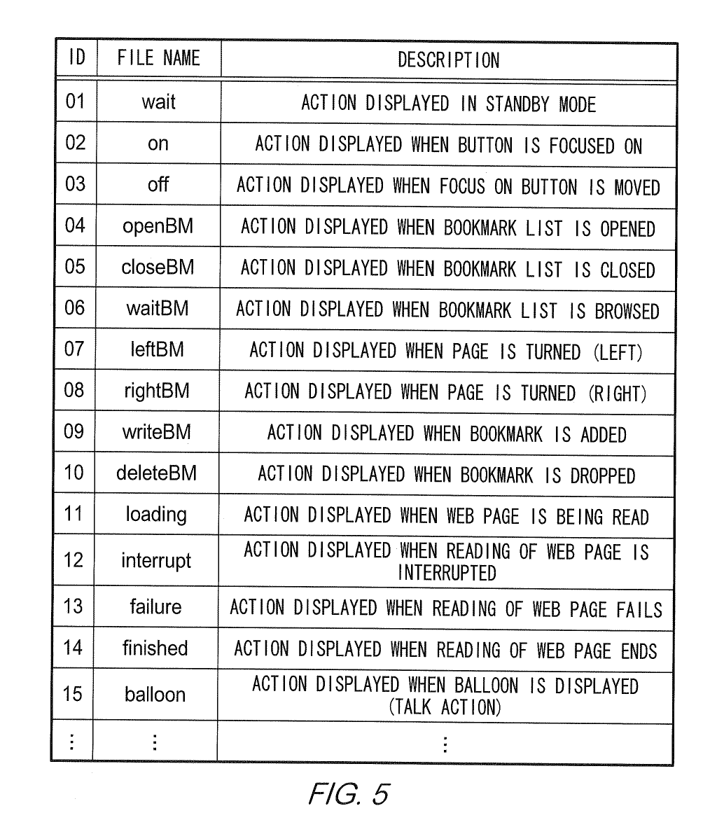

FIG. 5 is a diagram showing examples of animation files for displaying an animation of the avatar object. Information-processing device 100 stores animation files each describing an animated state (a display method), each of which corresponds to a processing status to be notified. For example, an animation file having an ID “01” is data that describes an action displayed in a standby mode, in which, although the toolbar is displayed, a user does not perform any operation, and an operation by a user is awaited. An animation file having an ID “02” is data describing an action displayed in a case where button image B1 is focused on so that an input to button image B1 can be accepted. An animation file having an ID “03” is data that indicates an action displayed in a case where a focus is moved from button image B1.

Among the animation files shown in FIG. 5, those having IDs “04” to “10” describe an animation that is displayed when the bookmarking function is being executed so that a bookmark list is displayed in area A1. Namely, the animation files are directed to notify a processing status relevant to the bookmarking function. Animation files having IDs “11” to “14” describe an animation that is displayed when the web browser function is being executed so that a web page is displayed in area A1. Namely, the animation files are directed to notify a processing status relevant to the web browser.

An animation file having an ID “15” describes an animation that is displayed when the avatar object provides a notification by way of a balloon. Information to be notified by way of a balloon may include a description for supporting operations input by a user (for example, an introduction to a function not in use), or various types of announcements. The balloon notification is made when a predetermined condition is satisfied. The balloon notification is also made based on a history of operations input by a user. However, information-processing device 100 provides the balloon notification only in predetermined situations (for example, in a standby mode or during a read operation of a web page), and does not prevent use or operation by a user. The balloon may be superimposed on the toolbar displayed in area A2 or an image displayed in area A1.

It is to be noted that the animation files shown in FIG. 5 are merely examples. There may be more or fewer animation files. For example, there may be an animation file that describes an action displayed when the toolbar reappears, or an action displayed when the toolbar is hidden.

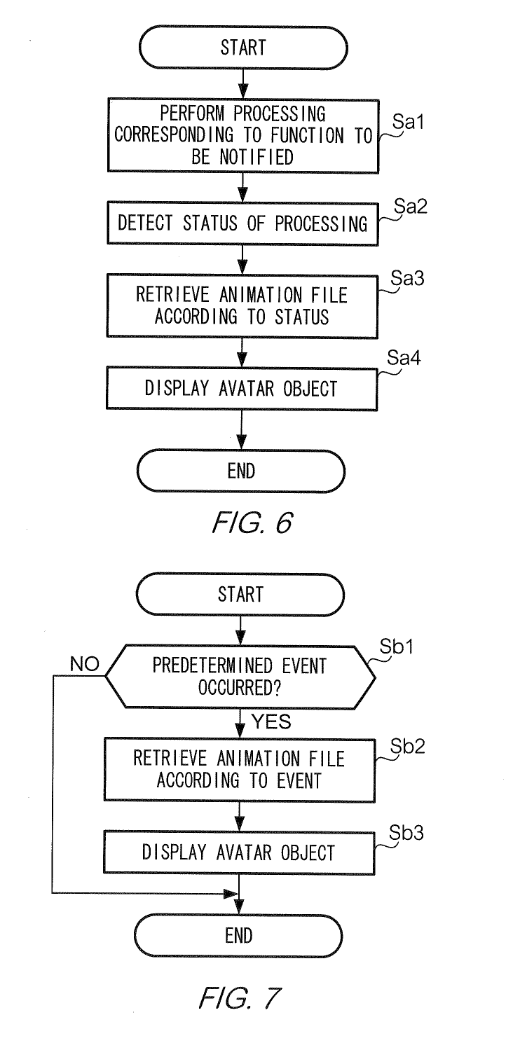

FIGS. 6 and 7 are flowcharts showing a processing performed by information-processing device 100 to display the avatar object. FIG. 6 shows a basic processing for displaying the avatar object. FIG. 7 shows an interrupt processing, which is triggered by a predetermined event during the execution of the processing shown in FIG. 6. The predetermined event may be an operation input by a user or a failure in data communication. Information-processing device 100 performs the processing shown in FIG. 6 when carrying out a predetermined processing, and if an event such as an operation input by a user occurs, information-processing device 100 performs the processing shown in FIG. 7 as an exceptional processing of the predetermined processing.

Control unit 110 of information-processing device 100 initially performs a processing corresponding to a function to be notified, as shown in FIG. 6 (step Sa1). In the present embodiment, the processing corresponding to a function to be notified is either a processing relevant to displaying of a web page or a processing relevant to displaying of a bookmark list. Accordingly, control unit 110 causes display unit 141 to display an image according to the processing in area A1 as a result of the processing of step Sa1. Control unit 110 is able to identify a processing to be notified, by determining whether the image displayed in area A1 is a web page or a bookmark list.

Subsequently, control unit 110 detects the status of the processing performed in step Sa1 (step S2). Thereafter, control unit 110 retrieves an animation file according to the status detected in step Sa2 (step Sa3), and causes display unit 141 to display an avatar object (step Sa4).

When performing the processing, control unit 110 performs the interrupt processing shown in FIG. 7 when needed. Specifically, control unit 110 determines whether a predetermined event has occurred (step Sb1), and if the predetermined event has occurred, control unit 110 retrieves an animation file according to the event (step Sb2), and causes display unit 141 to display an avatar object (step Sb3).

The predetermined event is an event relevant to a processing that requires a notification to a user. The predetermined event may be an input operation relevant to displaying of a bookmark list or a web page. The predetermined event is, in other words, an event for which a corresponding animation file has been prepared.

In step Sb3, control unit 110 fills the gap between the retrieved animation file and the currently played animation file, using an interpolation processing so that the animations are smoothly linked. As a result, the gap between the animations becomes less obvious, and it becomes easier to cause the avatar to appear to perform various types of actions.

A specific operation of the present embodiment is as follows. Initially, when a user does not input any operation, information-processing device 100 plays an animation file having an ID “01” for a standby mode to display an avatar object according to the file. At the time, in area A1, a web page (see FIG. 3) may be on display, or an image different from a web page or a bookmark list may be on display. Information-processing device 100 may play the animation file continuously.

In a case that a button image B1 is focused on as a result of an input operation by a user, information-processing device 100 plays an animation file having an ID “02” to switch the animation of the avatar object. The animation to be displayed may be an animation of the avatar giving a salute to a user. On the other hand, if a focus is moved away from button image B1 as a result of an operation input by a user, information-processing device 100 plays an animation file having an ID “03.” In this way information-processing device 100 switches an animation file for play in accordance with an operation input by a user. Upon switching of the animation file, information-processing device 100 fills a gap between the avatar objects by use of interpolation processing.

It is to be noted that the animation file having an ID “02” and the animation file having an ID “03” may be the same as each other. It also is to be noted that information-processing device 100 may display an animation of an avatar object not only in response to an input operation by a user that causes button image B1 to be focused on, but also in response to an input operation that causes any of button images B2 to B5 to be focused on. An animation to be displayed may be different or identical for each button image B1 to B5.

In the situation where button image B1 is focused on, if a user selects button image B1, information-processing device 100 switches an image displayed in area A1 from a web page to a bookmark list (see FIG. 4). When doing so, information-processing device 100 plays an animation file having an ID “04” to display an animation that notifies that a bookmark list has been opened by the selection of button image B1. The animation may be an animation of a book that is caused to appear in the hands of the avatar. The book corresponds to a book displayed in area A1.

After the bookmark list is displayed, information-processing device 100 switches the animation file of the avatar object, which is superimposed on button image B1, from the animation file having an ID “04” to an animation file having an ID “06.” As a result, the animation of the avatar object changes from the animation that notifies that the bookmark list has been opened, to an animation that indicates that an operation by a user is awaited. The avatar object to be displayed indicates that the bookmark list is receptive to an operation input by a user. Observing the avatar object, a user is able to confirm that the bookmark list has become receptive to an operation input by a user (a processing status corresponding to the bookmarking function).

If the bookmark list is hidden, and another image such as a web page is displayed in area A1, information-processing device 100 plays an animation file having an ID “05.”

In the bookmark list according to the present embodiment, a transition of a page is performed as if a page of the book of area A1 is turned. An operation for performing a page transition may be an input operation where button image BL or BR is selected. Alternatively, an operation for performing a page transition may be an input operation where a right or left flick toward the surface of touch screen unit 140 is made (an operation of sliding a finger that is in contact with the surface of touch screen unit 140). Information-processing device 100, on detecting such an operation, performs a transition of a page of the bookmark list displayed in area A1, and plays an animation file according to the operation (in this case, a file having an ID “07” or “08”). As a result, an animation is displayed of the avatar turning a page of the book held in a hand, which indicates that the bookmark list is in the process of a transition of a page (a status of a processing for performing a page transition).

As described in the foregoing, information-processing device 100 is able to notify a processing status in response to an input operation to button image B1 as well as an input operation different from that to button image B1, by way of an avatar object. Accordingly, a user is able to confirm a processing status in response to various operations by referring to an object displayed in a fixed position in the display area.

Also, a user is able to add a new URL to the bookmark list or drop a bookmark registered in the bookmark list. Such editing of the bookmark list may be performed by a user performing an input operation of pressing and holding an icon corresponding to a URL to be edited. Also, an operation of editing the bookmark list may be made to operation input unit 150, instead of touch screen unit 140.

In the process of editing the bookmark list, information-processing device 100 plays an animation file having an ID “09” or “10” to notify that the bookmark list is in the process of being edited, by way of the avatar object. After the editing of the bookmark list is concluded, information-processing device 100 plays the animation file having an ID “06” again, to notify that the bookmark list has returned to a standby mode, by way of the avatar object. A user is able to confirm a status of a processing for editing the bookmark list by viewing the animation of the avatar object.

Further, a user is able to browse a web page by selecting an icon corresponding to the web page, which is displayed in the bookmark list. Information-processing device 100, on detecting the selection of the icon, identifies a URL corresponding to the icon, and sends an HTTP (HyperText Transfer Protocol) request to an external server (web server) to receive a resource (data of a web page) identified by the identified URL

On receiving data of a web page, information-processing device 100 plays an animation file having an ID “11” until the web page is displayed, to notify that a web page is in the process of being read, by way of the avatar object. After reading of the web page is concluded, information-processing device 100 plays an animation file having an ID “14” to switch the animation of the avatar object. If a user performs an operation to suspend the reading of a web page, information-processing device 100 plays an animation file having an ID “12” to switch the animation of the avatar object. Alternatively, if the data of a web page has not been successfully received, due to trouble such as a network error, information-processing device 100 plays an animation file having an ID “13” to switch the animation of the avatar object. Accordingly, a user is able to confirm a processing status relevant to displaying of a web page, by referring to an animation of the avatar object.

As described in the foregoing, according to information-processing device 100, it is possible to notify processing statuses of a variety of types of processing performed in information-processing device 100 by way of an avatar object superimposed on button image B1. Also, since the avatar object is superimposed on button image B1, the area in which button image B1 is displayed has a combination of a function assigned to button image B1 and a function of notifying a processing status. Accordingly, it is not necessary to provide an additional area for notifying a processing status; namely, an effect is obtained of using the display area effectively. The effect is beneficial, especially in a device such as a handheld game machine, which has a display area limited in size.

Also, according to information-processing device 100, it is possible to confirm a processing status displayed in area A1 by referring to an avatar object displayed in area A2. Namely, an image displayed in area A1 and an image displayed in area A2 are closely linked. Accordingly, when a processing displayed in area A1 changes to another processing, a user is able to confirm a status of the other processing by referring to the avatar object superimposed on button image B1 of area A2.

Also, according to information-processing device 100, it is possible to notify a status of a processing performed in response to an input operation to button image B1 as well as a status of a processing performed in response to an input operation (a page transition in a bookmark list or reading of a web page) different from the input operation to button image B1, by way of an avatar object. Also, according to information-processing device 100, it is possible to notify a status of a processing corresponding to a function different from a function assigned to button image B1 (a function of displaying or hiding a bookmark list). Accordingly, a user is able to confirm a processing status for different functions by referring to an object displayed in an identical position in the display area. However, information-processing device 100 may be configured to notify only a status of a processing performed in response to an input operation to button image B1, or a status of a processing corresponding to a function assigned to button image B1.

Also, according to information-processing device 100, it is possible to confirm a status of various types of processing such as a page transition in a bookmark list or a reading of a web page by referring to an avatar object superimposed on button image B1. Accordingly, a user is able to confirm a status of various types of processing by referring to an identical position in the display area. A user is not required to refer to different positions in the display area to confirm statuses of various types of processing.

It is to be noted that in the present embodiment, an avatar object is represented as a polygonal object drawing using 3D computer graphics, and if an animation file for play is switched to another file, objects are smoothly linked using interpolation processing; however, the object superimposed on a button image does not always have to be a polygonal object or an image representing an avatar. The object superimposed on a button image may be an image representing a 2D character of a game.

### 3. Modifications

The above embodiment is illustrative only. The embodiment may be modified in the manners described below. The modifications described below may be used in various combinations.

### Modification 1

In the above embodiment, information-processing device 100 may display an image other than a web page or a bookmark list. Information-processing device 100 may display a desktop (a desktop environment) or a game screen.

In the above embodiment, the “link” may be a so-called soft link, instead of the hyperlink described above. A soft link is a mechanism for accessing a file or a directory stored in a storage area, which is also referred to as a shortcut, an alias, or a symbolic link. The desktop described above and a so-called home screen displayed on a smartphone are examples of a screen displaying a list of soft links.

### Modification 2

In the above embodiment, information-processing device 100 may be a device that can be used by plural users. In that case, information-processing device 100 may identify each user through an authentication process such as a login. Also, information-processing device 100 may provide different avatar objects for each user. To realize such a function, information-processing device 100 may store data on an avatar object for each user. Alternatively, information-processing device 100 may be a device by which each application can be used by plural users.

In the multiuser environment, an image such as a desktop or a bookmark list (an image displayed in area A1) may be different for each user. In that case, information-processing device 100 may provide different avatar objects as well as different desktops or bookmark lists, for each user. In that case, information-processing device 100 may change an avatar object in response to a change in an image such as a desktop or a bookmark list. According to the modifications, each user is able to use an avatar or links (hyperlinks or soft links) set for the user.

Also, an image displayed in area A1 is not limited to a desktop or a bookmark list, and it may be any other image, according to each user. Information-processing device 100 may display an avatar object according to a user in area A2 as well as displaying profile data of the user or a settings screen for the user in area A1.

### Modification 3

Information-processing device 100 may change the display magnification of an object (avatar object) when a predetermined condition is satisfied. In that case, button image B1 on which the object is displayed may be enlarged or reduced in proportion to the object. Alternatively, button image B1 may be displayed in a fixed size, regardless of the size of the object. In the latter case, the object may overlap button image B1.

For example, when an image displayed in area A1 is switched from a web page to a bookmark list or vice versa in response to an input operation by a user, or when a balloon notification is made, information-processing device 100 may enlarge an avatar object. According to this modification, the avatar object can appear more prominently. It is to be noted that the enlarged avatar object may be prepared based on an avatar object having an original size, or the enlarged avatar object may be prepared in advance.

### Modification 4

Information-processing device 100 according to the above embodiment is illustrative only. In the above embodiment, information-processing device 100 may be a stationary game machine, instead of a handheld game machine. Alternatively, information-processing device 100 may be a smartphone, a tablet device, or a portable music player. Also, it may not be necessary that information-processing device 100 include a communication unit.

Also, it may not be necessary that information-processing device 100 include an input unit. Information-processing device 100 may include a unit that obtains operation data from an input device such as a remote controller, instead of from an input unit. Also, an input unit provided in information-processing device 100 may be a unit that uses an infrared sensor or a motion sensor (a gyroscope or an acceleration sensor) to move a cursor or change a focus, instead of sensor unit 142 or operation input unit 150.

Also, it may not be necessary that information-processing device 100 include a display unit. Namely, in a case where a separate display device having a display unit is provided, information-processing device 100 may serve as a display control device that controls the display device.

### Modification 5

In the above embodiment, a processing or a function, whose processing status is notified in the display area of a button image, is not limited to that whose image is displayed in another display area (area A1). For example, a status of a processing performed in the background may be notified by way of an avatar object superimposed on a button image.

### Modification 6

Display control device 10 and information-processing device 100 described above are illustrative only. As another embodiment, a display control system may be provided, in which the functions of the display control device are distributed to plural devices. The display control system may include a display device having a display unit, and a control device that is able to access the display device via a network such as the Internet. The functions of the display control device or the information-processing device may be realized by cooperation of the two devices included in the display control system. Alternatively, the display control system may be realized by cooperation of a first device, which is a main device, and a second device, which is a subordinate device, that has wired or wireless connection to the first device. The first device may be a personal computer or a home-use game machine, and the second device may be a remote controller or a tablet device, which is able to communicate with the first device. Also, in a case where display control device 10 described above is provided as a single device, processing-performing unit 11, display control unit 12, and notification control unit 13 may be realized by using plural programs. Display control device 10 may be realized by using a program for processing-performing unit 11 and a program for display control unit 12 and notification control unit 13.

Also, as another embodiment, a display method for notifying a processing status by way of an object superimposed on a button image, or an information-processing program for realizing the display method may be provided. The information-processing program may be provided in the form of a storage medium such as an optical disk or a semiconductor memory. Alternatively, the information-processing program may be downloaded to an information-processing device via a network such as the Internet.

The foregoing description of the embodiments is provided for the purposes of illustration and description. It is not intended to be exhaustive or to limit the present technology to the precise forms disclosed. Obviously, a large number of possible modifications and variations will be apparent to practitioners skilled in the art. The embodiments were chosen and described in order to best explain the principles of the present technology and its practical applications, thereby enabling others skilled in the art to understand the present technology in various embodiments, and with the various modifications as suited to a particular use that may be contemplated. It is thus intended that the scope of the technology be defined by the following claims and their equivalents.

What is claimed is:

1. An information-processing device comprising:
a display control unit that causes a display unit to display a button image assigned to a function, the button image being selectable by a user, and an object superimposed on the button image;
a processing unit that performs a processing corresponding to the function when the button image displayed by the display unit is selected by a user; and
a notification control unit that notifies a status of at least the processing performed by the processing unit by changing an appearance of the object displayed by the display unit.

2. The information-processing device according to claim 1, wherein the notification control unit notifies a status of a processing corresponding to a function different from the function to which the button image is assigned, by changing an appearance of the object.

3. The information-processing device according to claim 2, wherein the function different from the function to which the button image is assigned is performed in response to an operation different from an operation assigned to the button image.

4. The information-processing device according to claim 1, wherein:
the display control unit causes the display unit to display another image different from the button image or the object as a result of the processing corresponding to the function; and
the notification control unit notifies a status of a processing corresponding to a function relevant to the other image by changing an appearance of the object.

5. The information-processing device according to claim 1, wherein the notification control unit notifies a status of a first processing corresponding to the function by making a first change to the object, and notifies a status of a second processing corresponding to the function by making a second change to the object.

6. The information-processing device according to claim 1, wherein the notification unit notifies the status of at least the processing by changing an appearance of the object continuously.

7. The information-processing device according to claim 1, wherein the object is an image drawn using 3D computer graphics.

8. The information-processing device according to claim 1, wherein the object represents an avatar.

9. The information-processing device according to claim 8, wherein the display control unit causes a display unit to display a button image on which the avatar is superimposed and data stored in a storage unit in association with the avatar.

10. The information-processing device according to claim 8, wherein the avatar varies for each user.

11. The information-processing device according to claim 1, wherein the notification control unit enlarges the object when a predetermined condition is satisfied.

12. A non-transitory computer readable medium storing a program that causes a computer to execute:
displaying a button image assigned to a function, the button image being selectable by a user, and an object superimposed on the button image;
performing a processing corresponding to the function when the button image displayed by the display unit is selected by a user; and
notifying a status of at least the processing performed by the processing unit by changing an appearance of the displayed object.

13. A display control system comprising:
a display control unit that causes a display unit to display a button image assigned to a function, the button image being selectable by a user, and an object superimposed on the button image;
a processing unit that performs a processing corresponding to the function when the button image displayed by the display unit is selected by a user; and
a notification control unit that notifies a status of at least the processing performed by the processing unit by changing an appearance of the object displayed by the display unit.

14. A display method comprising:
displaying a button image assigned to a function, the button image being selectable by a user, and an object superimposed on the button image; and
notifying a status of a processing corresponding at least to the function by changing an appearance of the object.
